(19) United States
(12) Patent Application Publication
(10) Pub. No.: US 2017/0110002 A1
(43) Pub. Date: Apr. 20, 2017

(54) SYSTEM AND METHOD FOR FIREFIGHTERS IMMINENT WARNING

(71) Applicant: Mike Jean-Jerome, Mount Vernon, NY (US)

(72) Inventor: Mike Jean-Jerome, Mount Vernon, NY (US)

(21) Appl. No.: 14/884,662

(22) Filed: Oct. 15, 2015

(51) Int. Cl. G08B 27/00; G08B 25/01

(52) U.S. Cl. CPC G08B 27/001; G08B 25/016

(57) ABSTRACT

Our system and method covers system and method for an imminent warning for firefighters.

### CROSS-REFERENCE TO RELATED APPLICATIONS

Not Applicable

### SEQUENCE LISTING OR PROGRAM

Not Applicable

### BACKGROUND

Field

This application relates to firefighters warning systems and methods.

Prior Art

The main purpose of The Last Call is to provide consumers with a device which facilitates the process of warning firefighters of imminent danger.

In U.S. Pat. No. 8,599,010, Bose et al describe a firefighter tracking system is provided for use in conjunction with a fire truck to track firefighters at the scene of a fire. The system a plurality of portable wireless transceiver tags each carried by a respective firefighter, an accelerometer within each of the plurality of portable wireless transceiver tags, a motion processor within each of the plurality of portable wireless transceiver tags coupled to the accelerometer, the motion processor processes information from the accelerometer, detects an immobilized state of the respective firefighter and wirelessly transmits information including a notification of the detected immobilized state, a gateway carried by the fire truck that receives the transmitted information from each of the plurality of portable wireless transceivers and a status processor coupled to the gateway within the fire truck programmed to determine and display a status of at least some of the firefighters at the location of the fire via the received information including at least the immobilized state of the at least some of the firefighters.

In U.S. Pat. No. 7,005,980, Schmidt and Tuttle describe a personal rescue signal system (PRSS) for quickly finding a transmitting target. More specifically, the PRSS includes as a personal rescue signal device (PRSD), worn on a person and emitting a radio frequency signal in an emergency condition. The PRSD is radio frequency coupled to a receiver within a handheld device and/or base unit. The handheld device would serve in directionally locating the PRSD source signal and also for range finding of the PRSD. One main intention of the PRSS is for rescue of firefighters down, or other operations where human life can quickly be put into harm's way.

In U.S. Pat. No. 7,377,835, Parkulo et al, describe a personal multimedia communication system and network for emergency services personnel includes a plurality of personal communication systems linked together and to a base station in a network. Each personal communication system includes a PDA device mounted on a PASS control console, a video camera mounted on the PDA device, a GPS unit, a microphone, and other electronic devices. The various electronic devices are all communicatively connected to the PDA device. Data from the various devices may be collected in the PDA device and wirelessly transmitted to any other node or device in the network, including other personal communication devices. Each personal communication device may serve as a repeater, thus providing a wireless communications link between a device located out of range of the base station.

In U.S. Pat. No. 5,990,793, Bieback describe an integrated safety and communication system for attachment to a standard type of firefighter's face mask includes a command post tracking and accountability monitor, and a mask attachment having means for transmitting the amplified voice of the wearer to anybody within its audible range, and to enable communications with the command post including identification, location, vital signs such as pulse and respiratory rate, vicinity temperature, hydrocarbon monitoring and alarm signal if the wearer becomes motionless for a predetermined time period.

In U.S. Pat. No. 5,877,676, Shankarappa describes an alerting device generates a variable alert that is varied to indicate the amount of time that has elapsed since the alert began. The alerting device has an alert signal detector, a timing unit, an alert signal generator and an alert unit. The alert signal detector responds to an activation signal to activate the timing unit, and the alert signal detector responds to a deactivation signal to reset the timing unit. The timing unit generates timing information to the alert signal generator indicating the elapsed time since the occurrence of the activation signal. The alert signal generator responds to the activation signal and to the timing information to generate an alert signal that indicates the elapsed time since the occurrence of the activation signal. The alert signal generator further responds to the deactivation signal to disable the alert signal. The alert unit responds to the alert signal to generate an alert that reflects the elapsed time since the occurrence of the activation signal.

In U.S. Pat. No. 5,774,050, Kagi describes the radio alarm security system, particularly for the protection of persons within a building against intruders, includes a mobile central alarm unit which is provided with a separate power source and is temporarily connectable to at least one charging station, and includes a receiver unit for the radio signals of alarm indicators, with a transmitter unit for producing radio signals for activating alarm generators as well as with an optical and acoustic display device for the received radio signals and at least hand-activatable initiating device for the radio signals activating the alarm generators.

In U.S. Pat. Pat. No. 4,906,972, Spencer describes a safety communications system for personnel employed in hazardous areas is responsive to motion sensing, as well as to worker initiated check-in signals, for registering an alarm at a central station after an absence of input for a predetermined time period. Confirmation of check-in and emergency transmission is also provided to the worker as assurance of system operation and to provide a local alarm to guide rescue efforts.

In U.S. Pat Application 2013/025-7612 Finet describes a personal alert safety system comprises a housing adapted to be worn by a user. An accelerometer is in the housing. An alarm device is operatively associated with the housing. A control in the housing is operatively connected to the accelerometer and the alarm device. The control is configured to operate the alarm device responsive to select acceleration movement of the housing sensed by the accelerometer.

### SUMMARY

Our invention consists of 6 separate items below: a device, an alarm, a speaker, a switch, a clip and a remote.

The main purpose of The Last Call is to provide consumers with a device which facilitates the process of warning firefighters of imminent danger. Firemen are often faced with life and death situations when they go to work as putting out fires which can spread out over large areas can often cause firefighters to become trapped. Moreover, instances where they have to rush into burning buildings that are filled with smoke can be an extremely dangerous as they are not always aware of the progression of the fires and can become trapped by unstable structures and falling debris, Ingenious, practical and life-saving, The Last Call is an innovative tool which affords an advanced system to alert users of impending danger. This groundbreaking apparatus is comprised of a device measuring 100×70×40 millimeters with an incorporated alarm, speakers, an on/off switch, a belt clip and a remote. Easy to use, this product clips onto the firefighter's belt and the remote is controlled by the fire chief; in the event of a dangerous situation such as a structural collapse, the remote is pressed by the chief which will automatically notify the firefighter by activating the vibrations on the corresponding device along with high pitch sounds and blinking lights signaling them to get out. The Last Call is essential for firefighters, tunnel workers, as well as search and rescue workers and may be readily available at industry specific retailers.

The Last Call is the only product of its kind that features a novel remote with a built-in activation button which acts as a last resort alarm to warn users to get out under life-threatening circumstance. The Last Call is uniquely designed to be manufactured with tough/rugged coverings for durability and to be battery powered for convenient on-the-go utilization.

### DRAWINGS—FIGURES

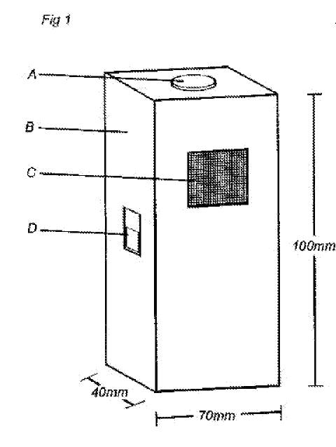

FIG. 1 Front view of fire fighter device;
a) Visual alarm;
b) Tough rugged material;
c) Speaker for alarm sound;
d) On/off;

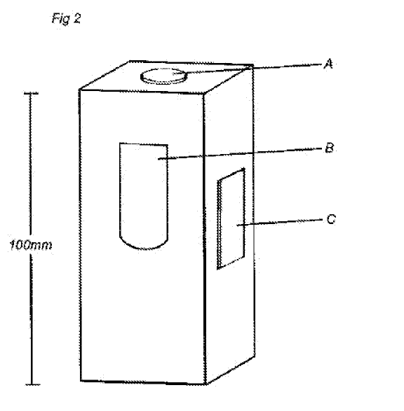

FIG. 2 Back view of fire fighter device;
a) Visual alarm;
b) Belt clip;
c) Vibrating device;

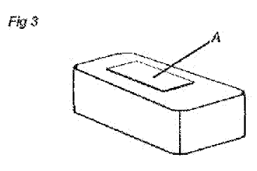

FIG. 3 Remote for Chief of Fire Department
a) Activation remote button;

### DETAILED DESCRIPTION—FIGS. 1, 2 AND 3—FIRST EMBODIMENT

Reference is made to FIG. 1 where we can see the Front View of the Fire Fighter Device, with 1 A showing the Visual Alarm, 1 B Tough Rugged Material, 1 C Speaker for Alarm Sound, 1 D On/off;

FIG. 2, shows the Back View of the Fire Fighter Device, with 2 A showing the visual alarm, 2 B Belt clip and 2 C vibrating device;

FIG. 3, shows the Remote For the Chief of the Fire Department, with 3 A showing the activation remote button.

I claim:

1) This system and method for an imminent warning for firefighters, which contains a:
a) Fire fighter warning system;
b) An alarm;
c) A Speaker;
d) A switch;
e) A clip;
f) A remote.

2) The system and method for an imminent warning for firefighters as in claim 1 comprising of a device measuring at least 100×70×40 millimeters.

3) The system and method as in claim 1, comprising:
a) Visual alarm;
b) Tough rugged material;
c) Speaker for alarm sound;
d) On/off.

5) The system and method as in claim 1, comprising:
a) Visual alarm;
b) Belt clip;
c) Vibrating device.

6) The system and method as in claim 1, comprising:
a) Fire Chief remote activation button.
